(19) United States
(12) Patent Application Publication
(10) Pub. No.: US 2014/0029411 A1
(43) Pub. Date: Jan. 30, 2014

(54) METHOD AND SYSTEM TO PROVIDE SEAMLESS DATA TRANSMISSION

(71) Applicant: SAMSUNG ELECTRONICS CO., LTD., Suwon-si (KR)

(72) Inventors: MITHUN MANJNATH NAYAK, Bangalore (IN); RANA PRASAD SAHU, Bangalore (IN); DEEP BERA, Bangalore (IN)

(73) Assignee: SAMSUNG ELECTRONICS CO., LTD., Suwon-si (KR)

(21) Appl. No.: 13/952,010

(22) Filed: Jul. 26, 2013

(30) Foreign Application Priority Data
Jul. 27, 2012 (IN) 3077/CHE/2012
Feb. 20, 2013 (KR) 10-2013-0017820

(51) Int. Cl. H04L 12/24; G06Q 50/22

(52) U.S. Cl. CPC H04L 41/0654; G06Q 50/22
USPC 370/219

(57) ABSTRACT

Seamless data transmission methods and apparatuses for seamless data transmission in ubiquitous health care environment are provided. The method to provide seamless data transmission includes receiving data collected by a sensor at a primary gateway; transmitting the data to a server; searching for backup gateways when the data transmission is interrupted; and selecting a backup gateway based on characteristics of the backup gateway.

### CROSS-REFERENCE TO RELATED APPLICATION

This application claims the benefit under 35 U.S.C. §119(a) of Indian Patent Application No. 3077/CHE/2012, filed on Jul. 27, 2012 in India Patent Office, and Korean Patent Application No. 10-2013-0017820, filed on Feb. 20, 2013 in the Korean Intellectual Property Office, the entire disclosure of which is incorporated herein by reference for all purposes.

### BACKGROUND

1. Field

The following description relates to patient's data transmission gateways in ubiquitous health care environment and to providing seamless data transmission by the gateway.

2. Description of the Related Art

Miniaturized implantable and on-body wireless biosensors are useful in monitoring the general health, monitoring the progression of chronic disease, assessing post-operative care, and the reaction of the body to complex therapeutic drug regimes. Body Area Networks (BAN) enables wireless communication between several miniaturized body sensor units (BSU) and a single body central unit (BCU) worn on the body. BAN has applications in ubiquitous healthcare systems, which is an emerging technology that enables monitoring patients as they maintain their normal everyday activities. It can warn patients or healthcare workers of problems detected in a patient, as well as collect data for trend analysis and medical research. The use of continuous monitoring allows both transient and progressive abnormalities to be reliably captured.

These implanted or on-body sensors are generally low power devices and hence cannot expend power on direct transmission to a medical center or healthcare unit but transmit the sensed data to a gateway near sensors, which further transmits this data to a medical care facility. The existing technology supports transmission of data from the sensors only if the gateway is in the range of the sensor. Even if the gateway is in range of the sensors, forwarding of data may be interrupted if the gateway is unable to transmit the data further to the medical facility due to any unavoidable circumstance. Due to above-mentioned reasons it is difficult to provide seamless data transmission in ubiquitous healthcare systems in case of gateway failure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method to provide seamless data transmission, the method including: receiving data collected by a sensor at a primary gateway; transmitting the data to a server; searching for backup gateways when the data transmission is interrupted; and selecting a backup gateway based on characteristics of the backup gateway.

The backup gateway may be a predefined gateway.

The backup gateway may be an on-the-fly gateway.

The characteristics of the backup gateway may be at least one of: network condition, power statistics, and network signal strength of the backup gateway.

The data transmission method may further include: authenticating the backup gateway; and transmitting the data to a server by the authenticated backup gateway.

The primary gateway and the alternative gateways may comprise at least one of: a communication device, a media player, and a personal computer.

The data transmission method may further include transmitting the data to a medical care facility by the selected backup gateway.

In another aspect, there is provided a computer program product embodied in a non-transitory computer readable medium including program instructions which when executed by a processor cause the processor to perform a method to provide a seamless data transmission, the method including: receiving data collected by a sensor at a primary gateway; transmitting the data to a server; searching for backup gateways when the data transmission is interrupted; and selecting a backup gateway based on characteristics of the backup gateway.

In another aspect, there is provided an apparatus to provide a seamless data transmission, the apparatus including: a primary gateway configured to receive data from a sensor and to transmit the received data to a server; the primary gateway is configured to search for a backup gateways when the data transmission is interrupted; and the primary gateway is configured to select a backup gateway based on characteristics of the backup gateway.

The primary gateway may be configured to search for backup gateways through a short-range communication medium.

The backup gateway may comprise a predefined gateway.

The backup gateway may comprise an on-the-fly gateway.

The primary gateway may be configured to provide authentication information to the backup gateway; and the backup gateway may be configured to receive data from a sensor and to transmit the received data to a server.

Other features and aspects may be apparent from the following detailed description, the drawings, and the claims.

### BRIEF DESCRIPTION OF THE DRAWINGS

FIG. 1 is a diagram illustrating examples of entities involved in existing ubiquitous health care environment.

FIG. 2 is a diagram illustrating examples of modules in the gateway.

FIG. 3 is a diagram illustrating an example of a method to select backup gateway.

FIG. 4 is a diagram illustrating an example of a sequence diagram for handover of data transmission from primary gateway to predefined gateway.

FIG. 5 is a diagram illustrating an example of a sequence diagram for handover of data transmission from primary gateway to an on-the-fly gateway.

FIG. 6 is a diagram illustrating an example of a computing environment implementing the method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. In addition, descriptions of well-known functions and constructions may be omitted for increased clarity and conciseness.

As described below, seamless data transmission is provided by using a backup predefined gateway when the primary gateway fails to transmit data from implanted body sensors to the intermediate Clinical Decision Support Server (CDSS) or another server at the medical care facility. The primary gateway may hand over transmitting data operation from the implanted body sensors intentionally to a backup gateway. Backup gateways may be discovered and the best gateway may be selected from the discovered multiple gateways, to transmit data either in case of the unavailability of the predefined gateway or in case the predefined gateway intentionally wants to hands over the data transfer operation to a backup gateway. Checks may be performed to determine whether the predefined gateway or backup multiple gateways have capability to transmit data.

As a non-exhaustive illustration only, the term “gateway” may refer to mobile devices such as, for example, a cellular phone, a smart phone, a wearable smart device (such as, for example, a watch, a glass, or the like), a tablet personal computer (PC), a personal digital assistant (PDA), a digital camera, an MP3 player, a portable/personal multimedia player (PMP), a portable game console, a handheld e-book, an ultra mobile personal computer (UMPC), a portable lab-top PC, a global positioning system (GPS) navigation, and devices such as a desktop PC, a high definition television (HDTV), an optical disc player, a setup box, and the like capable of wireless communication or network communication consistent with that disclosed herein. The gateways listed are provided as examples, and the primary gateway can be any device which can provide connectivity with the sensors and medical care facility.

As a non-exhaustive illustration only, the term “data” described herein may refer to physical and emotional data related to the behavior, life habits, health, and medical condition of a user or a patient being monitored. The data may include, but is not limited to, the data acquired by at least one sensor 101. The sensor 101 may be implanted in the body, or may be an on-body electronic, electromechanical, or biomechanical hardware device that record data such as, for example, blood-sugar levels and blood pressure of a user. The sensors listed above are provided as examples, and the sensor may include any type of sensor that is wired or wireless connected to the gateway and can transmit data to the gateway.

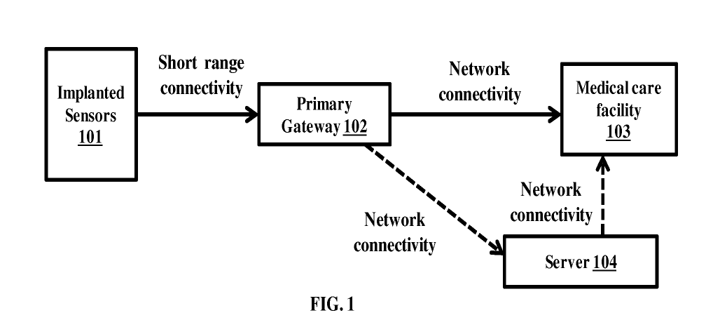

FIG. 1 is a diagram illustrating examples of entities involved in existing ubiquitous health care environment. As shown in FIG. 1, the BAN system includes sensors 101, a primary gateway 102, a medical care facility 103, and a server 104. The sensors 101 is paired with the primary gateway 102, which involves a discovery phase followed by negotiation and authentication, after which the data can be transferred securely from the sensors 101 to the primary gateway 102. The wireless communication between the sensors 101 and the primary gateway 102 can take place over any short-range connectivity protocol such as Bluetooth, Wireless Fidelity (Wi-Fi), Zigbee and such. The primary gateway 102 forwards data to the server at the medical care facility 103 for further health analysis of the patient. This communication between the gateway 102 and the medical care facility 103 can be made using Hyper Text Transfer Protocol (HTTP), Wi-Fi, WiMax, or any other mobile packet transfer based communication system.

The data transmitted by primary gateway 102 can be sent via a Clinical Detection Support Server (CDSS) 104 to the medical care facility 103. The CDSS enables pre analysis of data received from gateway 102 before forwarding it to the medical care facility 103. The CDSS server may not be needed if a medical attendant is available in the medical care facility for live monitoring of the received data of the patient being monitored. The data transmitted by sensors 101 can be event based or continuous. These sensors 101 can detect abnormal conditions in the sensed data based on standard detection algorithms and transmit only the “event” information or they can transmit sensed data continuously acting as recorders.

In ubiquitous health care where the patient is moving, the primary gateway 102 in existing systems can fail to provide seamless data transmission in situations such as loss of network connectivity of the primary gateway 102 with the medical care facility 103, or power shortage faced by the primary gateway 102, or when the primary gateway 102 may geographically move away from sensors 101, or any similar situations that may disrupt communication between sensors 101 and the medical care facility 103.

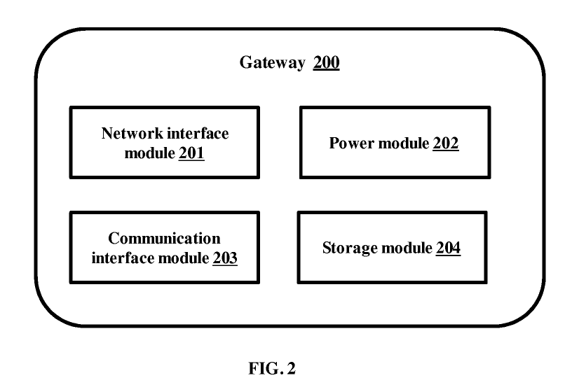

FIG. 2 is a diagram illustrating examples of modules in the gateway. As shown in FIG. 2, a gateway 200 may have a network interface module 201, a power module 202, a communication interface module 203, and a storage module 204. The network interface module 201 enables the gateway 200 to communicate with the sensors over short-range communication protocols such as Bluetooth, Wireless Fidelity (Wi-Fi), Zigbee and such. The power module 202 has a battery unit supplying power for the data transfer operations performed by gateway 200. The communication interface module 203 communicates with base station to enable the gateway 200 to forward the data to the server at the medical care facility 103 for further health analysis of the patient. This communication can be using HTTP, Wi-Fi, WiMax or any other mobile packet transfer based communication system. The storage module 204 can have an internal memory, such as Read Only Memory (ROM), Random Access Memory (RAM) or can be an external memory such as memory cards and such, which can store the data received from the sensors 101 and transmit it whenever required.

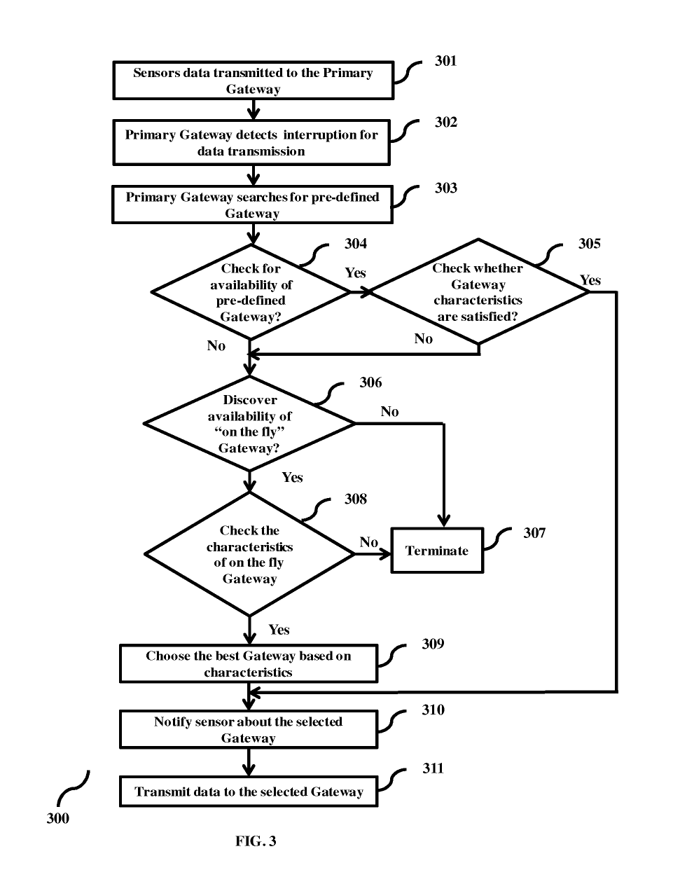

FIG. 3 is a diagram illustrating an example of a method 300 to select backup gateway. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently. As shown in FIG. 3, the diagram depicts different operations performed by a primary gateway 102, which is currently paired with sensors 101 to transmit data received from the sensors 101 to the medical care facility. The primary gateway 102 is the gateway 200 with which the sensor is initially paired.

In 301, the sensors transmit the sensed data to the primary gateway 102 which is in the short-range communication protocol. The primary gateway 102 further transmits this data to the medical care facility 103 via HTTP or any other protocol. In 302, the primary gateway 102 detects an interruption in data transmission. Such interruption can be a result of the primary gateway 102 being unable to transmit data due to loss of network connectivity between the medical facility centre 103, or shortage of power faced by the gateway to transmit the data, or loss of communication with the sensors 101 as a result of geographical separation of the gateway from the sensors and so on. The primary gateway 102 may also intentionally hands over the data transmission to a backup gateway.

If primary gateway 102 detects interruption for data transmission due to loss of network connectivity, the primary gateway stores the data in its storage module 204 for a pre-decided time interval ‘N’. If the network deterioration is temporary and the network is available within the interval N, the primary gateway transmits the stored data and then resumes normal data transmission, which is called store and forward mechanism. If the network deterioration continues beyond time interval N or if the interruption in data transmission is due to other reasons such as shortage of power faced by primary gateway 102 or primary gateway 102 geographically moving away from sensor, in 303, the primary gateway searches for a backup gateway. A predefined gateway may function as a backup gateway, and in 303, the primary gateway 102 searches for the predefined gateway. The predefined gateway may be selected by the primary gateway 102 in advance and may be another gateway the patient being monitored possesses. A predefined gateway may also resolve issues of privacy and trust. If a predefined gateway is discovered, in 304, the primary gateway checks for availability of the predefined gateway. If the predefined gateway is available, in 305, the primary gateway checks whether the predefined gateway characteristics are satisfactory before deciding to handover data transmission. The predefined gateway characteristics may be characteristics such as, for example network condition, power statistics, network signal strength, and such. Approximate power prediction techniques can be used to decide whether the pre-decided backup gateway has sufficient battery/power to sustain the transmission of the medical data. It can also be ascertained whether the predefined gateway has network connectivity to transmit the medical data.

If no predefined gateway is available or the predefined gateway does not satisfy the required device characteristics, in 306, the primary gateway 102 discovers the availability of backup on-the-fly gateways. The on-the-fly gateways are selected dynamically by the primary gateway 102. If the primary gateway 102 fails to discover the on-the-fly gateway, in 307, it will terminate the search. The on-the-fly gateways are discovered using an ad-hoc with services such as, for example, Wi-Fi, Bluetooth, Zigbee, and such. In an example, the primary gateway 102 may discover the on-the-fly gateway using the Wi-Fi ad-hoc protocol where the primary gateway 102 searches for the wireless networks available and initiates a peer-to-peer connection request. If there are no visible Wi-Fi gateways available, the primary gateway 102 scans for the Wi-Fi Media Access Layer (MAC) range and requests the available gateways for a peer-to-peer connection. After an ad-hoc network is set up, the primary gateway 102 sends a broadcast message to request for the characteristics of the gateways. All the gateways in the ad-hoc Wi-Fi network respond with their gateway characteristics such as, for example, the address, network condition, and such. In another example, the primary gateway 102 may use Bluetooth protocol to discover any gateways in the range, which respond to the primary gateway 102 with their gateway characteristics.

In 308, if the primary gateway 102 discovers any on-the-fly gateways, then the primary gateway 102 checks whether the characteristics of the on-the-fly gateways satisfy the requirement for handing over data transmission. In 307, if no gateway is found to match the characteristics, the search is terminated. If only one gateway satisfies the requirement, it is selected for handover. If multiple gateways are discovered that satisfy the gateway characteristics, then in 309, the primary gateway 102 selects the best on-the-fly gateway based on their gateway characteristics. The selected backup gateway can either be the predefined gateway that was checked in 305 or it can be the best on-the-fly gateway that was chosen in 309.

The handover parameters would include the Identifier/Address of the sensors 101 with which the selected backup gateway will pair with, and the credentials needed to authorize/identify the selected backup gateway to the server at medical care facility 103. The primary gateway informs the sensors 101 about termination of its communication and in 310 notifies the sensors 101 about the selected gateway for handover of data transmission. The selected on-the-fly gateway or the predefined gateway automatically connects with the sensors 101 using the identifier or address that is a part of the hand over from the primary gateway 102. The negotiation and authentication are done before the actual data transmission. The credentials enable the new on-the-fly gateway to identify/authorize itself to the server at the medical care facility 103. In 311, the sensor transmits data to the selected gateway.

An example of the method illustrated in FIG. 3 is described below. A patient with sensors 101 implanted, such as, for example, a pacemaker serving as Electro Cardio Graph (ECG) monitor, is being monitored at the medical care facility 103 can have his own mobile phone as a primary gateway 102. When the patient is travelling, the mobile phone can detect network deterioration and predict an interruption for data transmission, and can then look for other on-the-fly gateway. A mobile phone of the patient's companion traveler with acceptable gateway characteristics can be used as an on-the-fly backup gateway. These dynamic on-the-fly backup gateways present issues of un-trusted platforms that can misuse the confidential medical data. A zero knowledge proof protocol such as Direct Anonymous Attestation (DAA) may be carried out to confirm the trustworthiness of the platform of the on-the-fly backup gateway. DAA is a cryptographic protocol that enables the remote authentication of a trusted platform whilst preserving the user's privacy. Other authentication protocols, such as, for example AKA, PANA, and the like may be used without departing from the spirit and scope of the illustrative examples described.

As another example, the patient being monitored may be in an environment with limited mobility, e.g. a residence. In such a scenario the primary gateway 102 can handover its activity to a Personal Computer (PC), which may transmit the data to the server at the medical care facility (103).

When the primary gateway 102 detects that it is able to restart the transmission as its own battery, network and platform are ok, it sends a message to the backup gateway to hand back the transmission. On receiving this message from primary gateway 102, the backup gateway terminates the communication with the sensors 101 and primary gateway 102 resumes the communication. If the backup gateway faces insufficient power or network loss then it will make an effort to handover the transmission to the primary gateway 102.

To interpret the broadcast request by the primary gateway, a pre-installed, lightweight daemon process may execute on the devices in the ad-hoc network. The pre-installed software can be deployed onto the system in many different ways. For example, during the installation of the SIM records, the operator can install or request to install the software. Since this would be a vital, emergency service with legal approvals, the operator can install a version compatible with the platform of the mobile client. As another example, the software can be deployed over the air when the primary gateway sends a link to the gateways in ad-hoc network, which can then download and install the software. As yet another example, the pre-installed software can be implemented in a phone mandated by the local government.

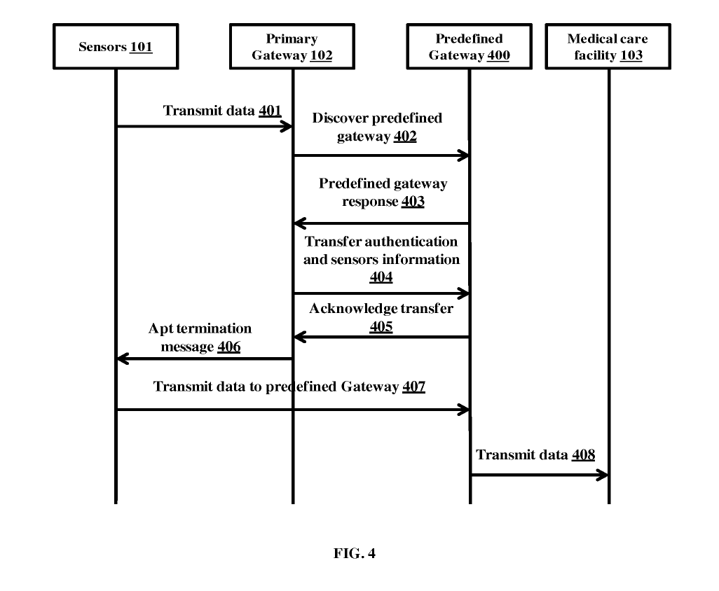

FIG. 4 is a diagram illustrating an example of a sequence diagram for handover of data transmission from primary gateway to predefined gateway. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently. FIG. 4 comprises sensors 101, a primary gateway 102, predefined gateway 400, and a medical care facility 103. In 401, the sensors 101 transmits the sensed data to the primary gateway 102. The primary gateway 102 may be unable to transmit data to the server at the medical care facility 103 or the primary gateway 102 may intentionally want to transfer data through a predefined gateway. Then, in 402, the primary gateway 102 initiates a process and discovers a predefined gateway 400 in the vicinity whose address is available with the primary gateway 102. In 403, the predefined responds to the primary gateway 102. On receiving the response, in 404, the primary gateway 102 transfers the secure authentication data, sensor related data (e.g. sensor ID) and server address to the predefined gateway 400. In 405, the predefined gateway acknowledges the data transferred by the primary gateway 102. Then, in 406, the primary gateway 102 terminates its communication with the sensor 101 by sending an apt termination message. After receiving the termination message, in 407, the sensor 101 transmits the data of a patient to the predefined gateway 400. In 408, the predefined gateway transmits the medical data to the medical care facility 103. The predefined gateway 400 may transmit data to a CDSS which pre analyzes the data and then forwards it to the medical care facility 103.

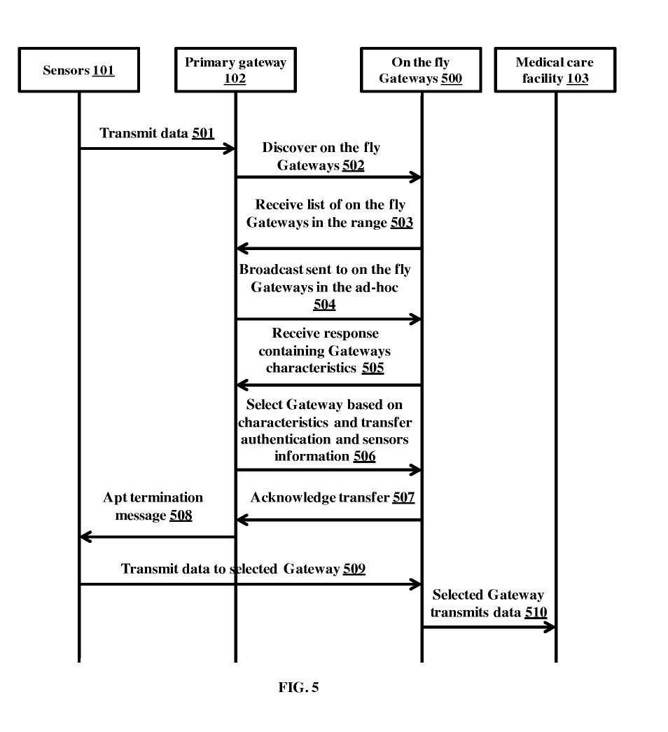

FIG. 5 is a diagram illustrating an example of a sequence diagram for handover of data transmission from primary gateway to an on-the-fly gateway. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. FIG. 5 comprises sensors 101, a primary gateway 102, on-the-fly gateway 500, and a medical care facility 103. In 501, the sensor 101 transmits the data to a primary gateway 102. The primary gateway 102 may be unable to transmit the data due to some interruption in the network or the primary gateway 102 may intentionally wants to transfer data through on-the-fly gateway. Then, in 502, the primary gateway 102 discovers on-the-fly gateways in the vicinity using ad-hoc services such as Wi-Fi, Bluetooth, Zigbee, and such. In 503, the primary gateway 102 receives a list of all on-the-fly gateways 500 in the primary gateway's 102 range. In 504, the primary gateway 102 sends a broadcast message to all on-the-fly gateways. On receiving the broadcast message, in 505, the on-the-fly gateways 500 responds with the gateway characteristics. In 506, the primary gateway 102 selects an on-the-fly gateway based on characteristics and transfer authentication and sensors information to the selected on-the-fly gateway. In 507, the on-the-fly gateway 500 acknowledges the transfer to the primary gateway 102. In 508, the primary gateway 102 terminates its communication with the sensor 101 by sending an apt termination message. After receiving the termination message, in 509, the sensor 101 transmits data to selected on-the-fly gateway 500. In 510, the on-the-fly gateway transmits the data to the medical care facility 103. The on-the-fly gateway 500 can transmit data to a CDSS which pre analyzes the data and then forwards it to the medical care facility 103.

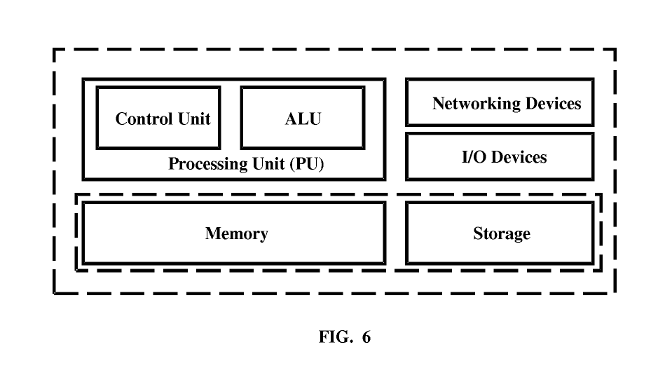

FIG. 6 is a diagram illustrating an example of an apparatus implementing the method. The apparatus and its components are for example only and the arrangement of some of the components may be changed or some of the components omitted without departing from the spirit and scope of the illustrative examples described. As shown in FIG. 6, the apparatus may comprise a processing unit (PU) that is equipped with a control unit and an Arithmetic Logic Unit (ALU), a memory, a storage unit, plurality of networking devices, and a plurality Input output (I/O) devices. The PU may be responsible for processing the instructions of the method. A plurality of PUs may be located on a single chip or over multiple chips. The processing unit may receives commands from the control unit in order to perform its processing. Logical and arithmetic operations involved in the execution of the instructions may be computed with the help of the ALU. The apparatus may be composed of multiple homogeneous and/or heterogeneous cores, multiple CPUs of different kinds, special media and other accelerators.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), CD-ROMs, magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein, including, but not limited to, the apparatuses and elements shown in FIGS. 1, 2 and 6 may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method to provide seamless data transmission, the method comprising:
receiving data collected by a sensor at a primary gateway;
transmitting the data to a server;
searching for backup gateways when the data transmission is interrupted; and
selecting a backup gateway based on characteristics of the backup gateway.

2. The data transmission method of claim 1, wherein the method further comprises searching for backup gateways through a short-range communication medium.

3. The data transmission method of claim 1, wherein the backup gateway is a predefined gateway.

4. The data transmission method of claim 1, wherein the backup gateway is an on-the-fly gateway.

5. The data transmission method of claim 1, wherein the characteristics of the backup gateway comprises at least one of: network condition, power statistics, and network signal strength of the backup gateway.

6. The data transmission method of claim 1, further comprising:
authenticating the backup gateway; and
transmitting the data to a server by the authenticated backup gateway.

7. The data transmission method of claim 1, wherein the primary gateway and the alternative gateways comprises at least one of: a communication device, a media player, and a personal computer.

8. The data transmission method of claim 1, wherein the method further comprises transmitting the data to a medical care facility by the selected backup gateway.

9. A non-transitory computer readable storage medium having thereon a program to execute the data transmission method of claim 1 with a computer.

10. A computer program product embodied in a non-transitory computer readable medium including program instructions which when executed by a processor cause the processor to perform a method to provide a seamless data transmission, the method comprising:
receiving data collected by a sensor at a primary gateway;
transmitting the data to a server;
searching for backup gateways when the data transmission is interrupted; and
selecting a backup gateway based on characteristics of the backup gateway.

11. A apparatus to provide a seamless data transmission, the apparatus comprising:
a primary gateway configured to receive data from a sensor and to transmit the received data to a server;
the primary gateway is configured to search for a backup gateways when the data transmission is interrupted; and
the primary gateway is configured to select a backup gateway based on characteristics of the backup gateway.

12. The apparatus of claim 11, wherein the primary gateway is configured to search for backup gateways through a short-range communication medium.

13. The apparatus of claim 11, wherein the backup gateway comprises a predefined gateway.

14. The apparatus of claim 11, wherein the backup gateway comprises an on-the-fly gateway.

15. The apparatus of claim 11, wherein the characteristics comprises at least one of network condition, power statistics, network signal strength of the backup gateway.

16. The apparatus of claim 11, wherein:
the primary gateway is configured to provide authentication information to the backup gateway; and
the backup gateway is configured to receive data from a sensor and to transmit the received data to a server.
